(19) United States
(12) Patent Application Publication
(10) Pub. No.: US 2016/0070507 A1
(43) Pub. Date: Mar. 10, 2016

(54) MEMORY SYSTEM AND METHOD OF CONTROLLING MEMORY DEVICE

(71) Applicant: Kabushiki Kaisha Toshiba, Minato-ku (JP)

(72) Inventors: Daisuke HOSHIKAWA, Yokohama (JP); Takuya Haga, Yokohama (JP); Shinya Takeda, Yokohama (JP)

(73) Assignee: Kabushiki Kaisha Toshiba, Minato-ku (JP)

(21) Appl. No.: 14/574,518

(22) Filed: Dec. 18, 2014

Related U.S. Application Data
(60) Provisional application No. 62/047,167, filed on Sep. 8, 2014.

(51) Int. Cl. G06F 3/06

(52) U.S. Cl. CPC G06F 3/0644; G06F 3/0613; G06F 3/0679

(57) ABSTRACT

According to one embodiment, a controller writes data in a first plane among the plurality of planes, and writes management information in a second plane among the plurality of planes. The controller performs a first process of reading first data from the first plane and a second process of reading the management information from the second plane in parallel. The management information is associated with second data to be read on and after next time.

### CROSS-REFERENCE TO RELATED APPLICATIONS

This application is based upon and claims the benefit of priority from U.S. Provisional Patent Application No. 62/047167, filed on Sep. 8, 2014; the entire contents of which are incorporated herein by reference.

### FIELD

Embodiments described herein relate generally to a memory system which includes a nonvolatile memory and a control method thereof.

### BACKGROUND

A nonvolatile memory such as a flash memory includes one or plural memory chips. Each memory chip is divided into a plurality of planes, and the each plane is capable of operation in parallel. Each plane includes a plurality of pages.

In order to realize the parallel operation among the plurality of planes in the memory chip, the different pages in the respective planes may be not designated in some cases. In such a case, when user data and management information are disposed in different pages of different planes, the user data and the management information should be independently read, so that the number of times of reading increases. Such a phenomenon can be remarkably found in a random read operation.

### BRIEF DESCRIPTION OF THE DRAWINGS

FIG. 1 is a functional block diagram illustrating an inner configuration of a memory system;

FIG. 2 is a diagram for describing a comparative example;

FIG. 3 is a diagram illustrating a read sequence according to the comparative example;

FIG. 4 is a diagram illustrating an exemplary memory state of management information and data according to a first embodiment;

FIG. 5 is a diagram illustrating a read sequence according to the first embodiment;

FIG. 6 is a diagram illustrating the read sequence according to the first embodiment;

FIG. 7 is a diagram illustrating the read sequence according to the first embodiment;

FIG. 8 is a diagram illustrating another exemplary memory state of the management information and the data according to the first embodiment;

FIG. 9 is a diagram illustrating an exemplary memory state of data and parity according to a second embodiment;

FIG. 10 is a diagram illustrating an ECC frame;

FIG. 11 is a flowchart illustrating a read process according to the second embodiment; and

FIG. 12 is a block diagram illustrating a memory system according to a third embodiment.

### DETAILED DESCRIPTION

According to embodiments, a memory system includes a nonvolatile memory and a controller. The nonvolatile memory includes a plurality of planes. Each plane includes a memory cell array and a page buffer. The controller controls the nonvolatile memory. The controller writes data to a first plane in the plurality of planes, and writes management information to a second plane in the plurality of planes. The controller performs a first process and a second process in parallel. The first process is composed of reading first data from the memory cell array of the first plane to the page buffer of the first plane. The second process is composed of reading the management information from the memory cell array of the second plane to the page buffer of the second plane. The management information is associated with second data to be read on and after next time from the memory cell array of the first plane to the page buffer of the first plane.

A memory system and a control method according to the embodiments will be described in detail with reference to the accompanying drawings. In addition, the invention is not limited to these embodiments.

### First Embodiment

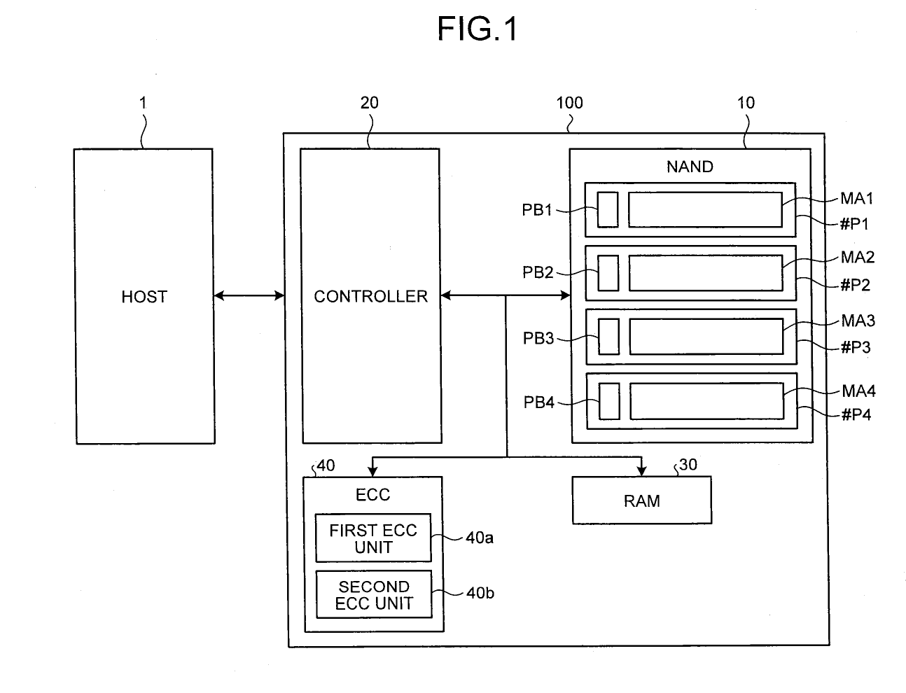

FIG. 1 is a block diagram illustrating an exemplary configuration of a memory system 100 according to a first embodiment. The memory system 100 is connected to a host apparatus (hereinafter, abbreviated as a host) 1, and functions as an external storage device of the host 1. The host 1 is for example a personal computer, mobile phone, imaging device, and the like.

The memory system 100 includes a NAND type flash memory (hereinafter, abbreviated as a NAND) 10 as a nonvolatile memory, a controller 20, a RAM 30, and an error correcting code (ECC) unit 40.

The NAND 10 stores user data which is designated by the host 1. The NAND 10 backs up the management information for managing the user data. The NAND 10 is configured by one or plural memory chips. In the following description, the NAND 10 will be assumed to be configured by one memory chip.

The memory chip includes a plurality of planes. The plurality of planes are provided on the same semiconductor substrate. In FIG. 1, the memory chip includes four planes #P1 to #P4.

The plane #P1 includes a page buffer PB1, a memory cell array MA1, and peripheral circuits (not illustrated). The plane #P2 includes a page buffer PB2, a memory cell array MA2, and peripheral circuits (not illustrated). The plane #P3 includes a page buffer PB3, a memory cell array MA3, and peripheral circuits (not illustrated). The plane #P4 includes a page buffer PB4, a memory cell array MA4, and peripheral circuits (not illustrated). Each of memory cell arrays MA1 to MA4 includes a plurality of blocks. Each block is a unit of data erasure. Each block includes a plurality of pages. Each page includes a plurality of memory cells. The page is a unit of data reading and data writing.

In one memory cell, one or plural bits of data can be stored. In a single level cell (SLC) mode, one-bit information can store in one memory cell. In a multi level cell (MLC) mode, two-bit information can store in one memory cell. In a triple level cell (TLC) mode, three-bit information can store in one memory cell.

The page buffer PB1 buffers data to be written in the memory cell array MA1 of the plane #P1 as much as one or plural pages. In addition, the page buffer PB1 buffers data read from the memory cell array MA1 of the plane #P1 as much as one or plural pages. Similarly, the page buffers PB2 to PB4 also buffer data to be written in the memory cell arrays MA2 to MA4 of the planes #P2 to #P4 as much as one or plural pages. The page buffers PB2 to PB4 buffer data read from the memory cell arrays MA2 to MA4 of the planes #P2 to #P4 as much as one or plural pages.

The planes #P1 and #P4 are provided with the peripheral circuits (for example, a row decoder, a column decoder, and the like) which are independent from each other, and can perform data transmission (a write process and a read process) in parallel between the memory cell arrays MA1 to MA4 and the page buffers PB1 to PB4. In addition, the parallel process means that the processes partially overlap each other between the planes #P1 and #P4, but do not need to completely overlap each other from start to end between the planes #P1 and #P4. In addition, when the data is read from the page buffers PB1 to PB4 of the planes #P1 to #P4 to the outside of the NAND 10, page data is serially read from the planes #P1 to #P4. Further, when the data is written from the outside of the NAND 10 to the page buffers PB1 to PB4 of the planes #P1 to #P4, the page data is serially written in the planes #P1 to #P4.

The random access memory (RAM) 30 is a memory which can be accessed with a higher speed than the NAND 10. Before writing the data from the host 1 in the page buffers PB1 to PB4 of the NAND 10, the RAM 30 temporally buffers the data. After the data requested to be read by the host 1 is read from the page buffers PB1 to PB4 of the NAND 10, the RAM 30 temporally buffers the data. Further, the management information stored in the NAND 10 is loaded onto the RAM 30 if necessary.

The management information includes a logical translation table, bad block management information, erasing count management information, column redundancy information, and the like. The logical translation table is a mapping table which shows a relation between a logical address (Logical Block Addressing (LBA)) designated by the host 1 and a storage position (a physical address) of the NAND 10. The bad block is a defective block which does not operate normally due to various factors and thus is unavailable.

The management information stored in the NAND 10 includes first management information A and second management information B. The first management information A is mapped to a relation between the LBA and a position of the second management information B stored in the NAND 10. The first management information A functions as a pointer to specify the position of the second management information B. The second management information B is a body portion of the management information, and includes the logical translation table, the bad block management information, the erasing count management information, the column redundancy information, and the like. The first management information A is stored at a predetermined position of the NAND 10, and loaded from the NAND 10 to the RAM 30 when the memory system 100 is powered up. The second management information B is loaded from the NAND 10 to the RAM 30 if necessary. Hereinafter, the first management information A will be referred to as pointer information, and the second management information B will be simply referred to as management information.

The controller 20 performs process corresponding to various types of commands according to the commands received from the host 1. The command process includes a process of reading data from the NAND 10, a process of writing data in the NAND 10, and the like. The controller 20, if necessary, updates the management information and the pointer information which are managed by the RAM 30.

The ECC unit 40 includes a first ECC unit 40a and a second ECC unit 40b. The ECC unit 40 performs an encoding process for the data to be written to the NAND 10 using an error correcting code, adds a parity obtained as a result of the encoding process to the write data, and outputs the resultant data to the NAND 10. Further, the ECC unit 40 performs a decoding process for the data read from the NAND 10 using the error correcting code, and performs error correction for the read data.

The first ECC unit 40a and the second ECC unit 40b perform the ECC processes which are different in error correction capability. The second ECC unit 40b has an error correction capability higher than that of the first ECC unit 40a. Therefore, in a case where the error correction is failed by the first ECC unit 40a, the error correction is performed by the second ECC unit 40b. The details of the first ECC unit 40a and the second ECC unit 40b will be described below.

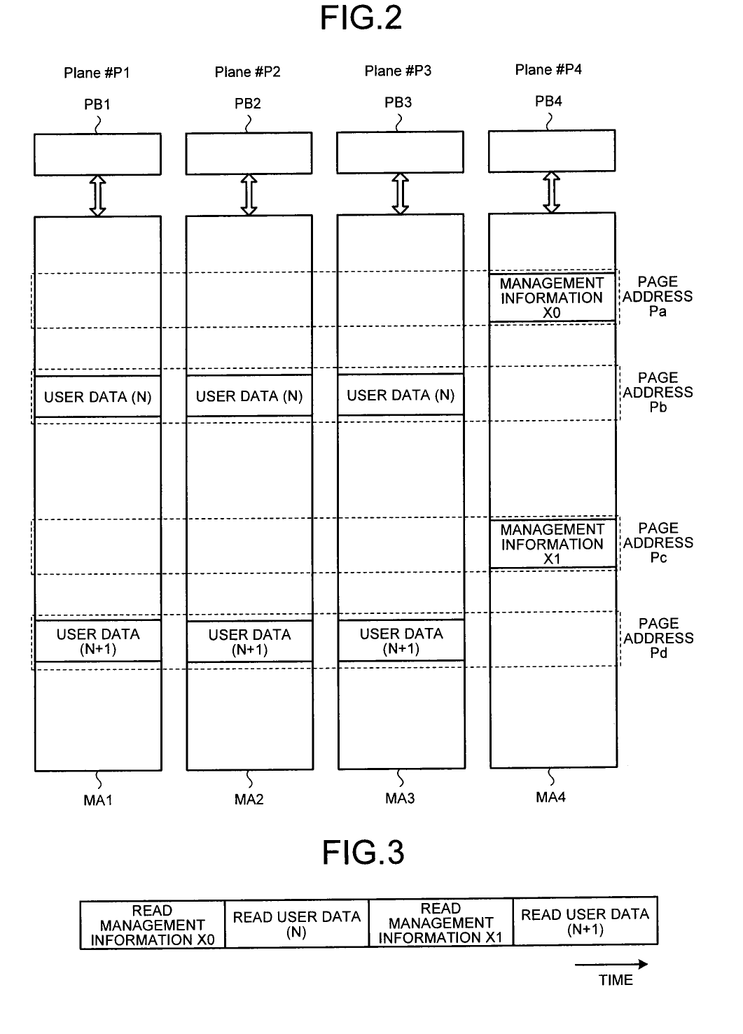

FIG. 2 is a diagram illustrating a NAND memory according to a comparative example. In FIG. 2, the user data is stored in the planes #P1 to #P3, and the management information is stored in the plane #P4. In the comparative example illustrated in FIG. 2, when the parallel operation is performed among the planes #P1 to #P4, there is a restriction that the respective planes are not allowed to be designated with different page addresses. The user data and the management information are stored in different pages of different planes. For example, user data N is stored at a page address Pb, and management information X0 for the user data N is stored at a page address Pa. Further, user data N+1 is stored at a page address Pd, and management information X1 for the user data N+1 is stored at a page address Pc.

FIG. 3 illustrates a sequence of reading the user data N and N+1. First, in order to read the management information X0 for the user data N, the reading is performed on the page address Pa in each of the planes #P1 to #P4. Next, in order to read the user data N, the reading is performed on the page address Pb in each of the planes #P1 to #P4. Then, in order to read management information X+1 for the user data N+1, the reading is performed on the page address Pc in each of the planes #P1 to #P4. Next, in order to read the user data N+1, the reading is performed on the page address Pd in each of the planes #P1 to #P4.

In the comparative example as described above, in a case where the management information is not stored at the same page address as that of the user data, the reading of the user data from the memory cell array to the page buffer and the reading of the management information from the memory cell array to the page buffer are not allowed to perform in parallel. Specifically, in a case of random read operation, there is a need to frequently read the management information from the NAND 10, and thus the number of times of reading (the reading count) increases. Therefore, a throughput of the reading process is lowered.

The NAND 10 of the embodiment can be designated with a different page address for each plane, when a parallel read and a parallel write are performed among the plurality of planes. The controller 20 stores the user data and the management information associated with the user data in different pages of the plurality of planes. Further, the read process from the memory cell array of the user data to be read this time to the page buffer and the read process from the memory cell array of the management information associated with the user data to be read later (on and after next time) to the page buffer are performed in parallel by the controller 20, so that the management information is read along with the user data in parallel among the plurality of planes.

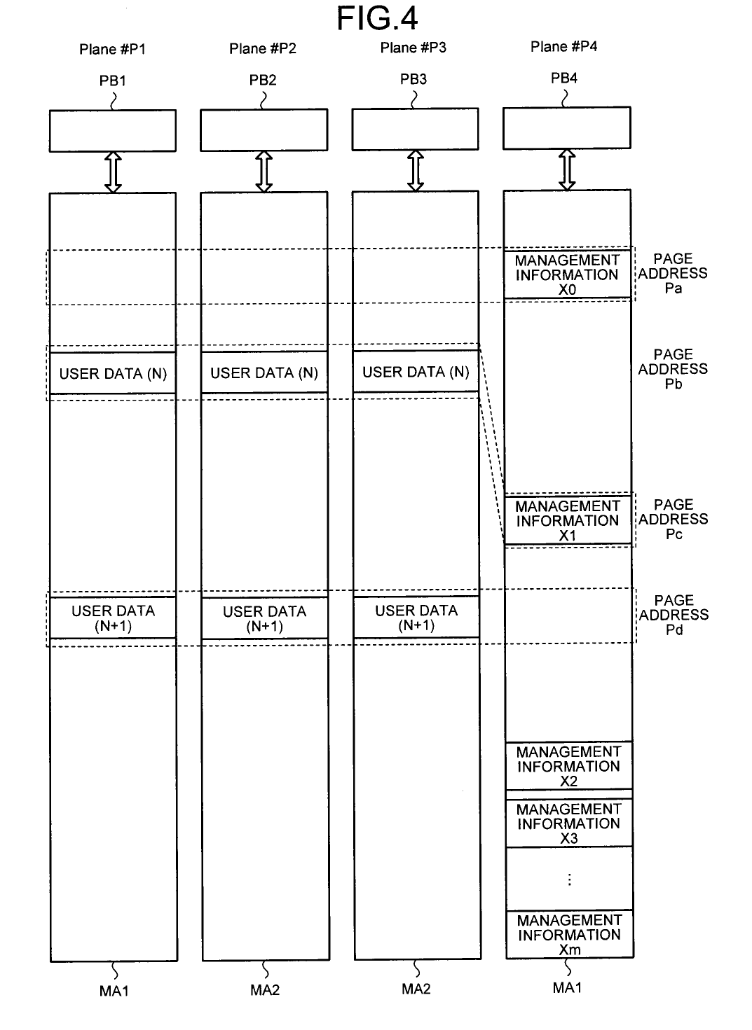

FIG. 4 is a diagram illustrating an example of an inner configuration of the NAND 10 according to the first embodiment. The NAND 10 includes four planes #P1 to #P4 in one memory chip. In the NAND 10, the memory cell arrays MA1 to MA4 and the page buffers PB1 to PB4 are provided for each plane. In FIG. 4, the user data is stored in the planes #P1 to #P3, and the management information is stored in the plane #P4. On a plurality of pages in the plane #P4, a plurality of pieces of management information X1 to Xm associated with the user data which is stored in the planes #P1 to #P3 are stored. For example, the user data N is stored at the page address Pb, and the management information X0 for the user data N is stored in the page address Pa. Further, the user data N+1 is stored at the page address Pd, and the management information X1 for the user data N+1 is stored in at the page address Pc. In the case of FIG. 4, the user data associated with one piece of management information is stored on the same page in the plurality of planes.

The management information stored on one page includes information which is associated with the user data stored on at least one page of the planes #P1 to #P3. In the embodiment, the management information stored on one page is assumed to include information which is associated with the management information stored in the plurality of pages of the planes #P1 to #P3.

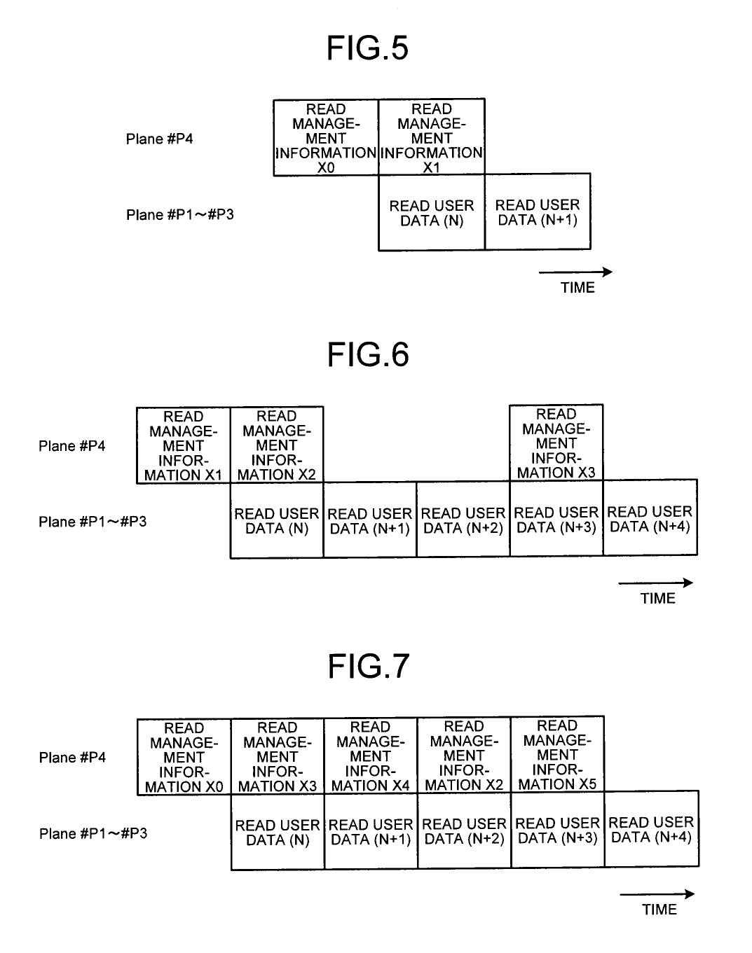

FIG. 5 illustrates a sequence of reading two pieces of user data N and N+1. The user data N is assumed to be associated with the management information X0, and the user data N+1 is assumed to be associated with the management information X1. The management information X0 is also associated with the user data other than the user data N. The management information X1 is also associated with the user data other than the user data N+1. First, the controller 20 acquires the page address Pa of the management information X0 of the user data N and the page address Pc of the management information X1 of the user data N+1 based on the pointer information. The controller 20 performs the read operations on the page addresses Pa of the planes #P1 to #P4 in order to acquire the management information X0, and loads the management information X0 onto the RAM 30. The controller 20 acquires the page address Pb of the user data N from the management information X0.

Next, the read operation from the page addresses Pb of the memory cell arrays MA1 to MA3 of the planes #P1 to #P3 to the page buffers PB1 to PB3 and the read operation from the page address Pc of the memory cell array MA4 of the plane #P4 to the page buffer PB4 are performed in parallel by the controller 20. Therefore, the user data N and the management information X1 are read into the page buffers PB1 to PB4 in parallel. The user data N and the management information X1 thus read are loaded onto the RAM 30. The controller 20 acquires the page address Pd of the user data N+1 from the management information X1. Next, the controller 20 performs the read operations on the page addresses Pd of the planes #P1 to #P4, reads the user data N+1 from the NAND 10, and loads the user data onto the RAM 30.

As described above, since the user data N and the management information for the user data N+1 are read in parallel, the number of times of read operations can be reduced compared to the comparative example.

FIG. 6 is a diagram illustrating an example of another read sequence according to the first embodiment. The management information X1 is associated with the user data N, the management information X2 is associated with the user data N+1, N+2, and N+3, and the management information X3 is associated with the user data N+4. The management information X1 and the user data N are stored in different pages, the management information X2 and the user data N+1, N+2, and N+3 are stored in different pages, and the management information X3 and the user data N+4 are stored in different pages.

In the first read operation, the controller 20 performs the read operations on the pages which include the management information X1 of the planes #P1 to #P4, and loads the read management information X1 onto the RAM 30. The controller 20 acquires the page address of the user data N by the management information X1. In the second read operation, the read operation on the page which includes the management information X2 of the plane #P4 from the memory cell array MA4 to the page buffer PB4 and the read operations on the pages which include the user data N of the planes #P1 to #P3 from the memory cell arrays MA1 to MA3 to the page buffers PB1 to PB3 are performed in parallel by the controller 20. The management information X2 and the user data N thus read are loaded onto the RAM 30. The controller 20 acquires the page addresses of the user data N+1, the user data N+2, and the user data N+3 based on the management information X2.

In the third read operation, the read operations on the pages which include the user data N+1 of the planes #P1 to #P3 are performed in parallel by the controller 20. At the time of the parallel read, in the plane #P4, the read operation may be performed on the same page as that of the user data N+1, or may not be performed. In the fourth read operation, the read operations on the pages which include the user data N+2 of the planes #P1 to #P3 are performed in parallel by the controller 20. In the fifth read operation, the read operation on the page which includes the management information X3 of the plane #P4 from the memory cell array MA4 to the page buffer PB4 and the read operations on the pages which include the user data N+3 of the planes #P1 to #P3 from the memory cell arrays MA1 to MA3 to the page buffers PB1 to PB3 are performed in parallel by the controller 20. The controller 20 acquires the page address of the user data N+4 based on the management information X3. In the sixth read operation, the read operations on the pages which include the user data N+4 of the planes #P1 to #P3 are performed in parallel by the controller 20.

FIG. 7 is a diagram illustrating an example of the read sequence in the case of a random read operation. The management information X0 is associated with the user data N, the management information X3 is associated with the user data N+1, the management information X4 is associated with the user data N+2, the management information X2 is associated with the user data N+3, and the management information X5 is associated with the user data N+4. During the random read operation, the management information which is disposed in a distributed manner in the plurality of pages of the plane #P4 has a strong possibility to be frequently read. In FIG. 6, the management information for the user data to be read this time and the user data to be read on and after next time is read in parallel and in a continuous manner. As a result, in the case of FIG. 7, the performance of transmitting the read data is improved twice or so compared to FIG. 3.

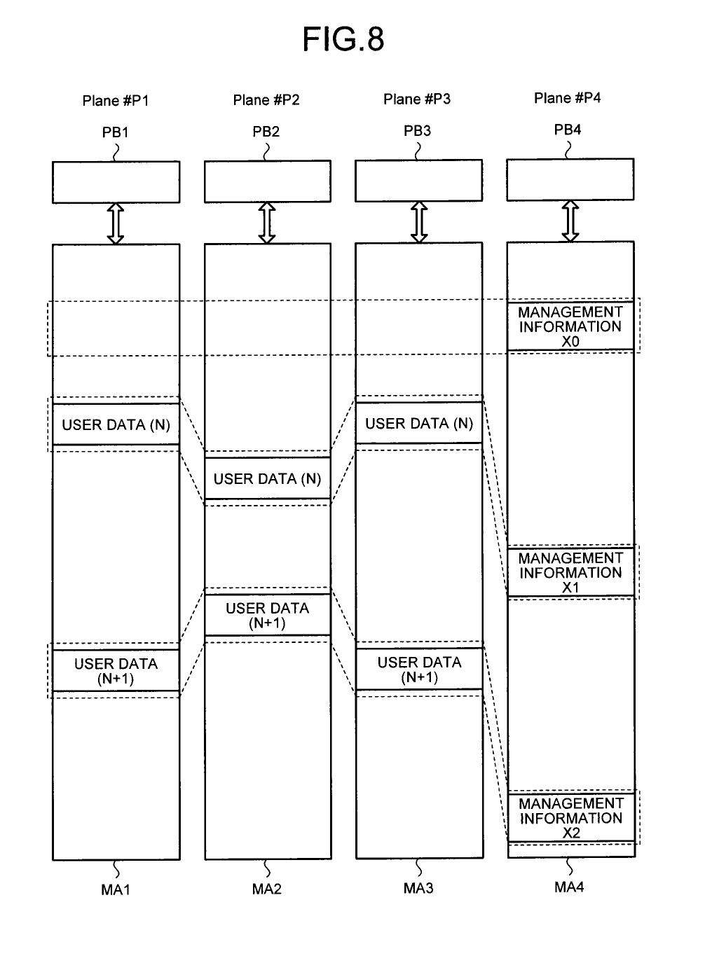

In the case of FIG. 4, when the parallel read operation is performed among the plurality of planes, the user data on the same page is designated. On the contrary, in FIG. 8, when the parallel read operation is performed among the plurality of planes, the user data on the different pages is designated. In the first embodiment, a scheme as illustrated in FIG. 8 may be employed.

In addition, the embodiment has been described about the case where the number of planes is four, but the number of planes may be arbitrarily set as long as two or more. Further, the embodiment has been described about the example where the management information is disposed in the plane #P4, the management information may be disposed in an arbitrary plane.

In the first embodiment as described above, when the parallel read operation is performed among the plurality of planes, the read process of the user data to be read this time and the read process of the management information associated with the user data to be read later are performed in parallel on the NAND 10 on which a different page address can be designated for each plane. Therefore, even in a case where the user data and the management information associated with the user data are written in different pages, the management information and the user data can be read in parallel among the plurality of planes, so that the number of read operations is reduced and the throughput of the read process is improved.

### Second Embodiment

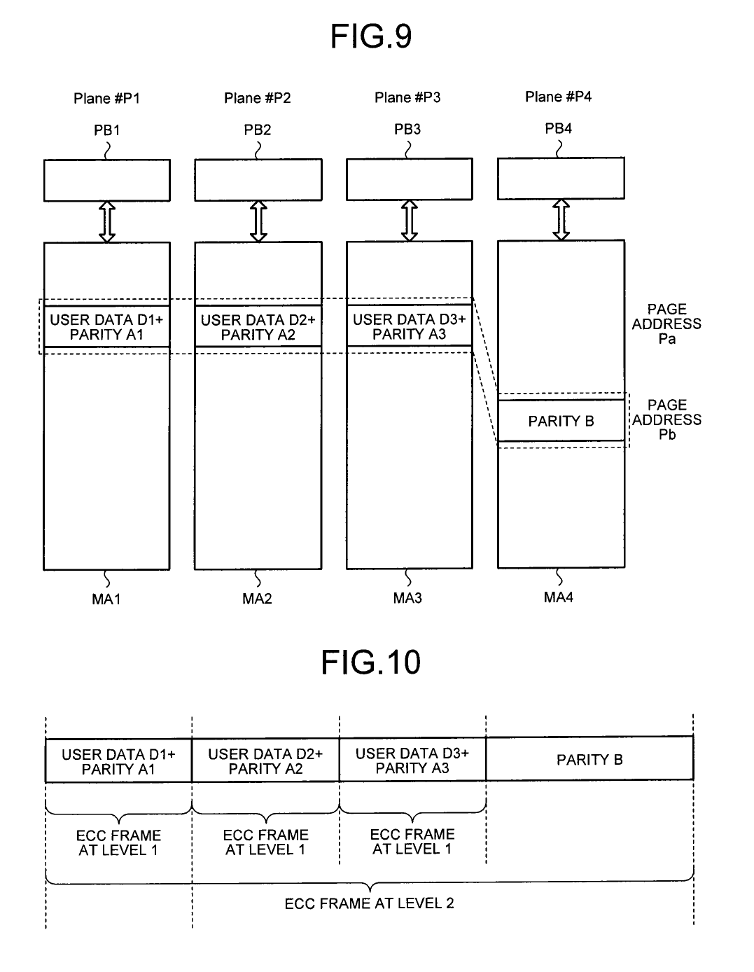

Even in a second embodiment, when the parallel read and the parallel write are performed among the plurality of planes, a different page address can be designated for each plane. FIG. 9 is a diagram illustrating data stored in the NAND 10 of the memory system 100 according to the second embodiment. In FIG. 9, user data D1 and a parity A1 are stored in the page address Pa of the plane #P1, user data D2 and a parity A2 are stored in the page address Pa of the plane #P2, and user data D3 and a parity A3 are stored in the page address Pa of the plane #P3. In the page address Pb of the plane #P4, a parity B is stored.

FIG. 10 is a diagram illustrating ECC frames which are generated by the first ECC unit 40a and the second ECC unit 40b. The parity A1 is created from page data D1. The ECC frame at a level 1 includes the page data D1 and the parity A1. Similarly, the ECC frame at the level 1 includes page data D2 and the parity A2. Similarly, the ECC frame at the level 1 includes page data D3 and the parity A3. The parities A1, A2, and A3 at the level 1 are created by the first ECC unit 40a of the ECC unit 40.

The parity B stored in the plane #P4 is created from the page data D1 and the parity A1 stored in the plane #P1, the page data D2 and the parity A2 stored in the plane #P2, and the page data D3 and the parity A3 stored in the plane #P3. The ECC frame at a level 2 includes three ECC frames at the level 1 stored in the planes #P1 to #P3 and the parity B stored in the plane #P4. The parity B at the level 2 is created by the second ECC unit 40b of the ECC unit 40.

The ECC at the level 1 is an inside-page ECC, and the ECC at the level 2 is an inter-page ECC or an inter-plane ECC. As described above, the ECC at the level 2 has an error correction capability higher than that of the ECC at the level 1.

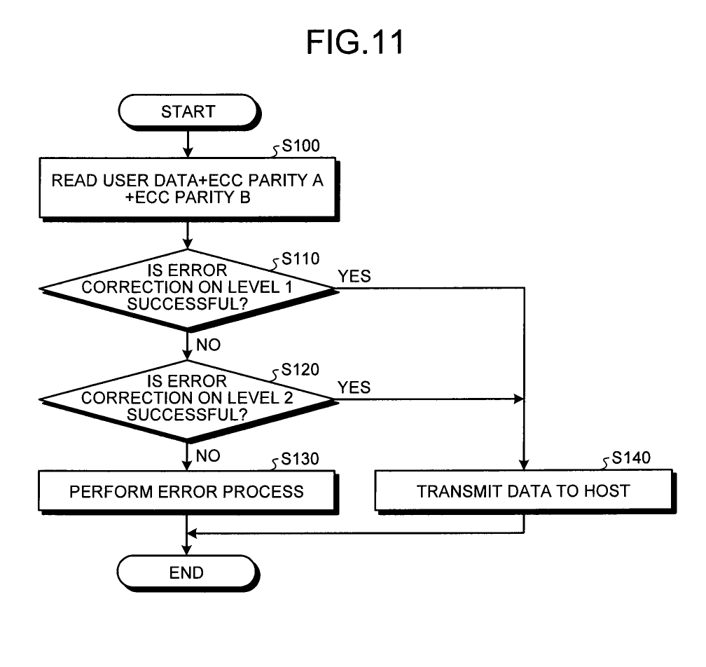

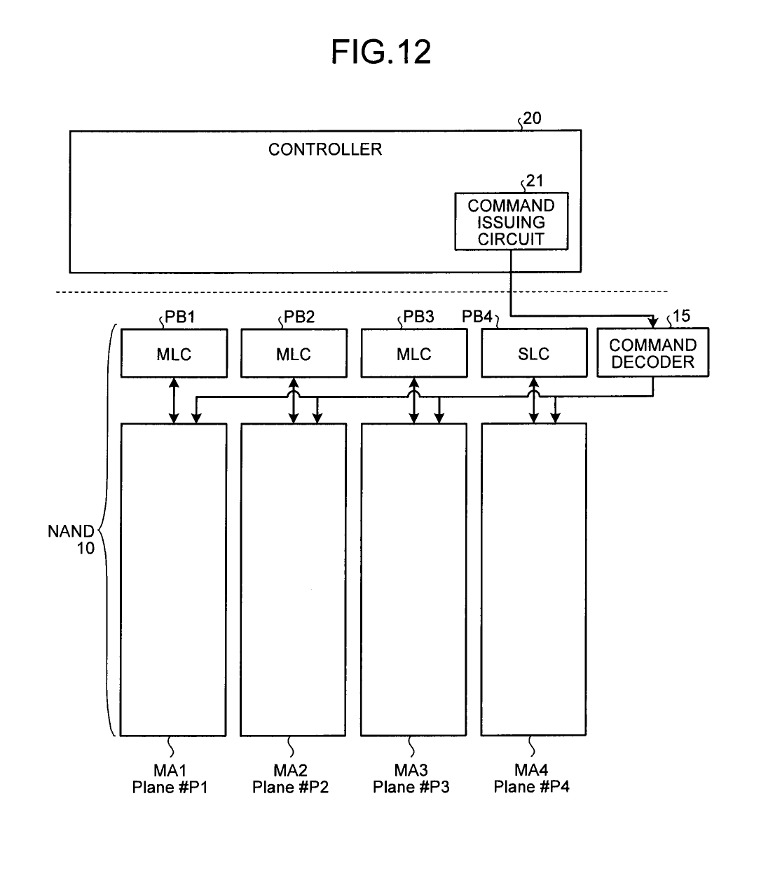

FIG. 11 illustrates the read process according to the second embodiment. In order to read the ECC frame at the level 2, the read operations on the page addresses Pa of the planes #P1 to #P3 from the memory cell arrays MA1 to MA3 to the page buffers PB1 to PB3 and the read operation on the page address Pb of the plane #P4 from the memory cell array MA4 to the page buffer PB4 are performed in parallel by the controller 20 (Step S100). The user data D1 to D3, the parities A1 to A3, and the parity B thus read are transmitted to the ECC unit 40. The first ECC unit 40a performs the error correction on the user data D1 using the parity A1, the error correction on the user data D2 using the parity A2, and the error correction on the user data D3 using the parity A3 (Step S110). In a case where the error corrections of the level 1 are all successful, the controller 20 transmits the corrected user data D1 to D3 to the host 1 through the RAM 30 (Step S140).

In Step S110, in a case where the error corrections of the level 1 are failed, the second ECC unit 40b performs the error correction on the ECC frame at the level 2 using the parity B (Step S120). In a case where the error correction of the level 2 is successful, the controller 20 transmits the corrected user data D1 to D3 to the host 1 through the RAM 30 (Step S140). In Step S120, in a case where the error correction of the level 2 is failed, the controller 20 performs a predetermined error process (Step S130).

In the second embodiment, the data portion (inside-page ECC frame) and the parity portion which are included in the inter-plane ECC frame are stored in different pages, and the data portion (inside-page ECC frame portion) and the parity portion which are included in the inter-plane ECC frame are read in parallel from the memory cell array to the page buffer. Therefore, it is possible to read the inside-page ECC frame and the parity of the inter-plane ECC frame which are stored in different pages in parallel. Further, it is possible to perform a plurality of different ECC processes by one read process.

### Third Embodiment

Even in a third embodiment, when the parallel read and the parallel write are performed among the plurality of planes, a different page address can be designated for each plane. Furthermore, in the NAND 10 according to the third embodiment, when the parallel read and the parallel write are performed among the plurality of planes, the SLC/MLC mode is designated in units of planes. When a parallel access is performed, a command issuing circuit 21 of the controller 20 issues an SLC/MLC command, which indicates which one of the SLC and MLC modes is used for each plane, to the NAND 10. Thereafter, the command issuing circuit 21 of the controller 20 issues a read command or a write command to the NAND 20.

On the other hand, when receiving the SLC/MLC command, a command decoder 15 included in the peripheral circuits in the NAND 10 decodes the SLC/MLC command, and instructs each of the planes #P1 to #P4 to operate in any one of the SLC and MLC modes based on the decoding result. Then, the command decoder decodes the read command or the write command thus received, and outputs the decoding result to each of the planes #P1 to #P4. With this configuration, in the NAND 10 according to the third embodiment, the read or write operation can be performed in one memory chip in which the SLC mode and the MLC mode are present together.

In the first embodiment, the user data is stored in the planes #P1 to #P3, and the management information is stored in the plane #P4. Herein, the recording in the SLC mode is performed in a short access time for writing or reading compared to the recording in the MLC mode, and there is a merit on that the operation is high in reliability. Therefore, in the third embodiment, the controller 20 stores the user data and the management information associated with the user data in different pages of the plurality of planes. Further, the user data stored in the planes #P1 to #P3 is written to the NAND 10 in the MLC mode, and the management information stored in the plane #P4 is written to the NAND 10 in the SLC mode. Further, the read process (the read process from the memory cell array to the page buffer) in the MLC mode of the user data to be read this time and the read process (the read process from the memory cell array to the page buffer) in the MLC mode of the management information associated with the user data to be read at least the next time (on and after next time) are performed in parallel by the controller 20.

In addition, the recording in the MLC mode is performed in a short access time for writing or reading compared to the recording in the TLC mode, and there is a merit on that the operation is high in reliability. Therefore, the user data may be written to the NAND 10 in the TLC mode, and the management information may be written to the NAND 10 in the SLC or MLC mode. In other words, the management information is written in a first mode, and the user data is written in a second mode. When n is set to two or more, the first mode is an n-valued program mode, and the second mode is a multi-valued (higher than the n value) program mode.

In the second embodiment, the user data and the parity at the level 1 are stored in the planes #P1 to #P3, and the parity at the level 2 is stored in the plane #P4. In the third embodiment, the controller 20 stores the user data, the parity at the level 1, and the parity at the level 2 in different pages of the plurality of planes. Further, the user data and the parity at the level 1 stored in the planes #P1 to #P3 are written to the NAND 10 in the MLC mode, and the parity at the level 2 stored in the plane #P4 is written to the NAND 10 in the SLC mode. Further, the read process (the read process from the memory cell array to the page buffer) performed in the MLC mode of the user data and the parity at the level 1 stored in the planes #P1 to #P3 and the read process (the read process from the memory cell array to the page buffer) performed in the SLC mode of the parity at the level 2 stored in the plane #P4 are performed in parallel by the controller 20.

In addition, the user data and the parity at the level 1 are written in the NAND 10 in the TLC mode, the parity at the level 2 is written in the NAND 10 in the SLC or MLC mode.

In the third embodiment as described above, when the parallel read and the parallel write are performed to the plurality of planes, each plane is configured to be designated between the SLC mode and the MLC mode, and thus the parallel read can be performed among the planes in which the SLC mode and the MLC mode are present together.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a nonvolatile memory including a plurality of planes, each of the planes including a memory cell array and a page buffer; and
a controller configured to:
write data in a memory cell array of a first plane among the plurality of planes;
write management information in a memory cell array of a second plane among the plurality of planes; and
perform a first process and a second process in parallel, the first process being composed of reading first data from the memory cell array of the first plane to the page buffer of the first plane, the second process being composed of reading the management information from the memory cell array of the second plane to the page buffer of the second plane, the management information being associated with second data to be read on and after next time from the memory cell array of the first plane to the page buffer of the first plane.

2. The memory system according to claim 1, wherein
each of the memory cell arrays includes a plurality of pages,
the nonvolatile memory is capable of operation in parallel among the pages with different page addresses in the plurality of planes,
the controller is configured to write the first data in a first page of the first plane, and to write the management information in a second page of the second plane, the second page being different from the first page.

3. The memory system according to claim 2, wherein
the first plane includes a plurality of planes, and
the second plane includes one plane.

4. The memory system according to claim 3, wherein
the second data associated with the management information is written in the same pages of the plurality of planes.

5. The memory system according to claim 3, wherein
the second data associated with the management information is written in different pages of the plurality of planes.

6. The memory system according to claim 2, wherein
in a case that the second data is corresponding to multiple times of reading,
the controller reads the first data from the first plane, and do not read the management information from the second plane.

7. The memory system according to claim 2,
wherein the memory cell is capable of storing m-bit data, where m is one or more,
wherein the controller is configured to
write the management information in a first mode from the page buffer of the second plane to the memory cell array of the second plane, the first mode being an n-valued program mode, and
write the data in a second mode from the page buffer of the first plane to the memory cell array of the first plane, the second mode being a multi-valued program mode, the multi-value being higher than the n value, where n is two or more, and
wherein the controller is configured to
read the management information in the first mode from the memory cell array of the second plane to the page buffer of the second plane, and
read the data in the second mode from the memory cell array of the first plane to the page buffer of the first plane.

8. The memory system according to claim 9, wherein
the controller issues a command to the nonvolatile memory to instruct each plane to operate in any one of the first mode and the second mode.

9. A memory system comprising:
a nonvolatile memory including a plurality of planes, each of the planes including a memory cell array and a page buffer, each of the memory cell arrays including a plurality of pages, the nonvolatile memory being capable of operation in parallel among the pages with different page addresses in the plurality of planes; and
a controller configured to:
write data and a first parity in a first page of a first plane among the plurality of planes, the first parity being created base on the data;
write a second parity in a second page of a second plane among the plurality of planes, the second parity being created based on the data and the first parity written in the first page; and
perform a read process from the first page of the first plane to the page buffer of the first plane and a read process from the second page of the second plane to the page buffer of the first plane in parallel.

10. The memory system according to claim 9, wherein
an error correction capability of the second parity is higher than an error correction capability of the first parity.

11. A method of controlling a memory device which includes a nonvolatile memory, the nonvolatile memory being configured to include a plurality of planes, each of the planes including a memory cell array and a page buffer, the method comprising:
writing data in a memory cell array of a first plane among the plurality of planes;
writing management information in a memory cell array of a second plane among the plurality of planes; and
performing a first process and a second process in parallel, the first process being composed of reading first data from the memory cell array of the first plane to the page buffer of the first plane, the second process being composed of reading the management information from the memory cell array of the second plane to the page buffer of the second plane, the management information being associated with second data to be read on and after next time from the memory cell array of the first plane to the page buffer of the first plane.

12. The method according to claim 11, wherein
each of the memory cell arrays includes a plurality of pages,
the nonvolatile memory is capable of operation in parallel among the pages with different page addresses in the plurality of planes, the method further comprising:
writing the first data in a first page of the first plane; and
writing the management information in a second page of the second plane, the second page being different from the first page.

13. The method according to claim 12, wherein
the first plane includes a plurality of planes, and
the second plane includes one plane.

14. The method according to claim 13, wherein
the second data associated with the management information is written in the same pages of the plurality of planes.

15. The method according to claim 13, wherein
the second data associated with the management information is written in different pages of the plurality of planes.

16. The method according to claim 12, further comprising:
in a case that the second data is corresponding to multiple times of reading,
reading the first data from the first plane, and not reading the management information from the second plane.

17. The method according to claim 12,
wherein the memory cell is capable of storing m-bit data, where m is one or more,
the method further comprising
writing the management information in a first mode from the page buffer of the second plane to the memory cell array of the second plane, the first mode being an n-valued program mode, and
writing the data in a second mode from the page buffer of the first plane to the memory cell array of the first plane, the second mode being a multi-valued program mode, the multi-value being higher than the n value, where n is two or more,
reading the management information in the first mode from the memory cell array of the second plane to the page buffer of the second plane, and
reading the data in the second mode from the memory cell array of the first plane to the page buffer of the first plane.

18. The method according to claim 17, further comprising:
issuing a command to the nonvolatile memory to instruct each plane to operate in any one of the first mode and the second mode.
